(19) United States
(12) Patent Application Publication
(10) Pub. No.: US 2013/0060606 A1
(43) Pub. Date: Mar. 7, 2013

(54) EFFICIENT CONTRACTING WITH ASYMMETRIC INFORMATION

(71) Applicants: Rico Knapper, Karlsruhe (DE); Andrzej Kochut, Croton-on-Hudson, NY (US); Ajay Mohindra, Yorktown Heights, NY (US); Anca Sailer, Scarsdale, NY (US)

(72) Inventors: Rico Knapper, Karlsruhe (DE); Andrzej Kochut, Croton-on-Hudson, NY (US); Ajay Mohindra, Yorktown Heights, NY (US); Anca Sailer, Scarsdale, NY (US)

(73) Assignee: International Business Machines Corporation, Armonk, NY (US)

(21) Appl. No.: 13/289,188

(22) Filed: Nov. 4, 2011

Related U.S. Application Data
(60) Provisional application No. 61/530,568, filed on Sep. 2, 2011.

(51) Int. Cl. G06Q 30/02

(52) U.S. Cl. 705/7.33

(57) ABSTRACT

Techniques include accessing predetermined utility of customers based on customer types and qualities. The qualities are based at least on previously identified non-functional characteristics of services that influence decisions of the customers in buying the services from a service provider. Based at least on the accessed predetermining utility, quality-price pairs are determined to create a predetermined amount of profit for the service provider assuming the service provider offers the services to a customer having the customer type at a level of quality corresponding to an associated one of the qualities in a pair and for the corresponding price in the pair. Each quality in the pairs corresponds to one of the customer types. Determining the price-quality pairs further includes mapping one or more of the service-related characteristics to one or more information technology resources in response to the service-related characteristic being dependent on one or more other service-related characteristics.

### BACKGROUND

This invention relates generally to services, and, more specifically, relates to efficient contracting with asymmetric information, for instance in cloud services.

Increasing popularity of cloud-based services has led to the emergence of cloud marketplaces where services from different providers are offered and combined based on standardized, uniformed interfaces.

Decisions by customers about buying offered services are based on customer-specific preferences regarding non-functional characteristics of the service, such as price, provider reputation, and quality of service. The preferences of the customers are not necessarily known to providers at the time the service (including pricing) is defined in a catalog of marketplace services. Thus, from a microeconomic perspective, one has to consider information asymmetry on incomplete markets. On such markets, finding the optimal contracts (e.g., non-functional characteristics and prices) that maximize profit of a provider is challenging due to information uncertainty. Such markets include cloud-based services but may also include other markets.

### SUMMARY

Techniques include accessing predetermined utility of customers based on customer types and qualities. The qualities are based at least on previously identified non-functional characteristics of services that influence decisions of the customers in buying the services from a service provider. Based at least on the accessed predetermining utility, quality-price pairs are determined to create a predetermined amount of profit for the service provider assuming the service provider offers the services to a customer having the customer type at a level of quality corresponding to an associated one of the qualities in a pair and for the corresponding price in the pair. Each quality in the pairs corresponds to one of the customer types. Determining the price-quality pairs further includes mapping one or more of the service-related characteristics to one or more information technology resources in response to the service-related characteristic being dependent on one or more other service-related characteristics.

### BRIEF DESCRIPTION OF THE SEVERAL VIEWS OF THE DRAWINGS

FIG. 1 shows a table of customer types and offering allocation for an introductory example.

FIG. 2 is a platform scenario for embodiments of the instant invention.

FIG. 3 is an illustration of five main steps of an exemplary screening approach.

FIG. 4 shows a table of provider-related NFCs (non-functional characteristics).

FIG. 5 shows a table of a formalization of empirical results.

FIG. 6 shows a table of an example of non-independent NFCs and their impact on the value of the utility function dependent on the (mathematical) character of the function.

FIG. 7 shows a table listing preferences of example customer types with respect to provider and service quality, where preferences are expressed using fitting functions (ƒ) and relative weights (λ).

FIG. 8, including FIGS. 8A and 8B, includes graphs of infrastructure properties.

FIG. 9, including FIGS. 9A, 9B, and 9C, illustrates valuation functions that occur after combination of the infrastructure profiles in FIG. 8 with the utility surfaces as shown in the table in FIG. 7. That is, FIG. 9 illustrates the results of a mapping extension to handle dependent NFCs (depicted by the surfaces shown in FIGS. 7 and 8).

FIG. 10 is a block diagram of an exemplary system for performing exemplary embodiments of the instant invention.

### DETAILED DESCRIPTION

A generic economic framework is presented herein based on contract theory, and the framework solves the problem of finding optimal contracts described above in the Background section for single services. The instant contribution includes the following: (i) an analysis and selection from non-functional provider characteristics that are considered by customers when deciding which services to buy; (ii) implementation of a holistic contracting framework that grants providers maximal profit through optimal combination of potential values of the chosen attributes; and (iii) presentation of a study of a desktop service use case. The framework addresses the phenomenon of adverse selection by leveraging, in an exemplary embodiment, a screening technique.

For ease of reference, the instant disclosure is divided into a number of sections. The introduction section that follows also introduces other sections.

### 1. INTRODUCTION

With the rise of the Internet and its fast growing service ecosystems, cloud platforms play a central role enabling the exchange of services. Cloud platforms are solutions on top of a cloud infrastructure that facilitate the component-based assembly, trade, and provision of value-added services. Instead of having to develop applications entirely from scratch, application fragments such as simple (e.g., Web) services and third-party software libraries can be dynamically retrieved from and assembled in the cloud. Many companies offer composable services. Certain platforms offer so-called “published applications” for re-use. Other platforms provide for the deployment and management of frameworks for code development in the cloud. These other platforms, for instance, enable developers to write their applications, upload their code into the cloud, and run the applications in a Web-based manner. Developers do not have to care about issues like system scalability as the usage of their applications grows. Additionally, platforms enable managing the whole tailored business applications lifecycle from the cloud.

Although still in its infancy, cloud ecosystems, where buyers and suppliers come together to buy and sell information technology (IT) services, have started emerging. For example, the company Zimory provides software that enables multiple enterprises to offer and share services for dynamic IT infrastructures. These services can then be composed with services from other providers for a richer set of cloud-based services. For example, a buyer can purchase compute services from provider A, a management service from provider B, while a data backup and restore service is from provider C. In an ideal environment, the management services and the data backup restore service would work seamlessly with the compute services from provider A. In the future, it is envisioned that IT services might be complemented by business-level services.

From a micro economic perspective, cloud marketplaces embody an environment that enables the trade between market participants, i.e., the exchange of services between service providers and service customers, similarly to the exchange of goods on traditional markets. Information (e.g., on service quality, willingness to pay for a particular service) is not common knowledge in such markets. It is distributed asymmetrically among the participants, that is, this information is private to the individuals that own the information prior to trade. More precisely, on the supply side of the cloud market, service providers have private information on their quality of services and valuation and lack the information on the preferences of customers and willingness to pay. On the demand side, service customers have private information on their preferences for service quality and the price they are willing to pay. As participants in such a market they are assumed to behave strategically, i.e., to strive to maximize their individual utility (an economic concept which measures the extent to which a good or service satisfies a want or need of the customer). In conclusion, similarly to traditional markets enabling exchange of goods between providers and customers, cloud marketplaces are equally markets with asymmetric information. In such environments, service providers typically are uncertain about the preferences of customers for quality and price. Hence, their offerings are designed based on average expectations about the customer preferences, i.e., they offer services with a mean quality at a mean price. Consequently this lack of price differentiation leads to the loss of various customer types. This whole development is known as the phenomenon of “adverse selection”, which is addressed below and is to be solved for cloud service marketplaces.

The remainder of this disclosure is structured as follows: Section 2 exemplifies a non-limiting problem definition by a motivating example and in Section 3 requirements upon a screening framework for cloud service marketplaces are identified. Based on these results, Section 4 introduces a screening framework subdivided into five exemplary main steps. To demonstrate the suitability of the disclosed framework in a real-world scenario, Section 5 provides an extended application scenario. Section 6 provides addition implementation examples. Finally, Section 7 summarizes certain exemplary contributions.

### 2. MOTIVATING EXAMPLE

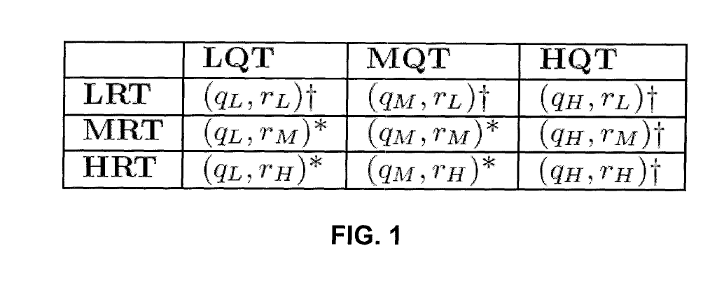

For illustration of the adverse selection phenomenon in cloud service markets, let s denote a service of a provider that may be offered in three different variants consisting of quality-price-pairs: (q_{L},p_{L}), (q_{M},p_{M}), and (q_{H},p_{H}) with q denoting the quality of the service and p denoting the corresponding price at the levels low (L), medium (M), and high (H) (p_{L}<p_{M}<p_{H}). On the demand side, there are nine different types of customers tᵢ defined by pairs of quality q and reservation price r (maximum willingness to pay) such that tᵢ=(qₙ,rₘ) with n,mε{L,M,H}. It is assumed that customer types are distributed uniformly. As the provider is not able to observe a type of customer individually and thus is uncertain about the distribution of customer types in general, the service is offered in the medium variant (q_{M},p_{M}) only. Based on this offering, the following types will sign a contract: (q_{L},r_{M}), (q_{L},r_{H}), (q_{M},r_{M}), (q_{M},r_{H}). This results in a revenue for the provider of 4p_{M} as illustrated in FIG. 1, which shows a table of customer types and offering allocation. Regarding the quality type dimension, LQT denotes low quality types, MQT medium quality types, and HQT high quality types. The price type dimension is specified by LRT meaning low reservation price types, MRT medium reservation price types, and HRT high reservation price types. Types indicated by an asterisk (*) will sign a contract for the offering (q_{M},p_{M}). Types indicated with a cross ( [symbol] ) will leave the platform.

In such a setting, the premium customer types (q_{H},rₘ) with mε{L,M,H} are not addressed by the mediocre offering and will consequently leave the platform. This leads to a reduction of potential customer types to the low and medium quality types, which in turn diminishes the mean quality of the offering of the service provider, who still faces informational uncertainty. As a final outcome, the effect of adverse selection fosters a spiral of decreasing quality which finally leads to a low quality market with minimum revenues. Regarding this issue, one may ask the following question: “How would the provider know what the mean quality and price are, if the provider does not know the preferences and willingness to pay of a customer?” This is a suitable question, but consider the following:

1. The knowledge is not important since this spiral occurs starting with every price/quality pair; and

2. The example of the spiral is just a theoretical example to illustrate the phenomenon without aspiring to map the example to the “real” world.

As mitigation for adverse selection in cloud service markets, an optimal solution, in an exemplary embodiment, is provided for service providers to elicit customer types in a cloud market. The instant solution allows for an efficient design of a service catalog (set of offerings) that implements equilibrium in dominant strategies where customers reveal their types truthfully. The term “equilibrium” refers to a condition on markets, where each market participant has chosen a strategy and no participant can benefit by changing his or her strategy while the other participants keep their strategies unchanged. In this situation, the current set of strategy choices and the corresponding payoffs constitutes a (Nash) equilibrium. The term “dominant strategy” refers to a strategy in game theory which leads to a maximized utility value for the market participant choosing this strategy independent of the strategies other market participants choose.

To this aim, the discussion below is threefold: (i) the relevant buying factors are identified for customers by analyzing prior solutions; (ii) a holistic economic framework is provided based on the method of screening to mitigate adverse selection and enable the design and pricing of offerings for single and complex services; finally, (iii) the applicability of the framework is demonstrated in a real-world cloud scenario.

### 3. SCOPE & RELATED WORK

This section specifies the context (e.g., assumptions and requirements) of the instant disclosure from an economic and mathematical perspective regarding a screening framework to mitigate adverse selection in cloud service markets and enable an efficient pricing of cloud service offerings. Following this structure, related work in the corresponding fields is outlined and discussed.

3.1 Assumptions

Two assumptions are described that are relevant to a cloud service scenario.

The first assumption (Assumption 1, asymmetric information) is as follows. From an economic perspective, cloud service markets enable the trade of services between providers and customers. There exist different types of service exchange information relevant to participants in the market. As stated in the introduction, such information is not openly accessible for all parties, i.e., information is incomplete and asymmetrically distributed among providers and customers.

Both uncertainties on the customer side as well as on the provider side are addressed in the literature. For the customer side, see Ba, S. and Whinston, A. B. and Zhang, H., “Building trust in the electronic market through an economic incentive mechanism”, Proceedings of the 20th international conference on Information Systems, pages 208-213, 1999; and Tellis, G. J. and Wernerfelt, B., “Competitive price and quality under asymmetric information”, Marketing Science, 6(3):240-253, 1987. For the provider side, see Corbett, C. J. and De Groote, X., “A supplier's optimal quantity discount policy under asymmetric information”, Management Science, 46(3):444-450, 2000. Authors in Tellis (“Competitive price and quality under asymmetric information”) investigate markets with asymmetrically informed consumers, i.e., consumers are uncertain about the price of offerings and quality. Electronic transactions with asymmetric information focusing on trust are analyzed in Ba (“Building trust in the electronic market through an economic incentive mechanism”). The authors develop as a mitigation an incentive mechanism teased on a trust certificate authority. The strategy of the seller to set optimal quantities to overcome inefficiencies caused by asymmetric information in such a market is addressed in the following for the supply chain domain: Corbett (“A supplier's optimal quantity discount policy under asymmetric information”).

The second assumption (Assumption 2, pre-contractual uncertainty) is as follows. It is important to notice that the provider's uncertainty about the customer's quality preferences and reservation price exists before the contract is signed (pre-contractual). In economic theory this fact leads to the phenomenon of adverse selection in contrary to the moral hazard, which occurs post-contractual. For adverse selection, see Akerlof, G. A., “The Market For ‘Lemons’: Quality Uncertainty And The Market Mechanism”, The Quarterly Journal Of Economics, 84(3):488-500, 1970. Regarding the moral hazard, see Holmstrom, B., “Moral Hazard And Observability. The Theory Of The Firm: Critical Perspectives On Business And Management”, 10:89, 2000. This temporal dimension has strong implications on the design of an adequate economic framework. Moral hazard refers to a fundamental incentive problem in the insurance industry: “When an insuree gets financial or other coverage against a bad event from an insurer, he or she is likely to be less careful in trying to avoid the bad outcome against which she is insured.” This effect (which has to be taken into account from insurance companies while designing their contract offerings) is called moral hazard.

Electronic markets that observe both effects—adverse selection and moral hazard—are analyzed in Dellarocas, C., “Efficiency Through Feedback-Contingent Fees And Rewards In Auction Marketplaces With Adverse Selection And Moral Hazard”, Proceedings of the 4th ACM Conference on Electronic Commerce, pages 11-18, 2003. Meanwhile, adverse selection in electronic markets is addressed focusing on the level of information uncertainty in online auctions and on the impact of reputation of the sellers in Dewan, S. and Hsu, V., “Adverse Selection In Electronic Markets Evidence From Online Stamp Auctions”, The Journal of Industrial Economics”, 52(4):497-516, 2004. Adverse selection effects are compared in traditional and electronic markets in Fabel, O. and Lehmann, E. E., “Adverse Selection And Market Substitution by Electronic Trade”, International Journal of the Economics of Business, 9(2):175-193, 2002.

3.2 Exemplary Requirements

Typically adverse selection is addressed by signaling or screening. Signaling is leveraged when the informed party moves first, which is not the case in cloud markets, since the provider has to offer first the catalog of services to enable customer subscription. In this section, exemplary requirements are outlined for providing screening in cloud service markets. Furthermore, related literature is discussed that focuses on screening models in the light of each requirement.

A first exemplary requirement (Requirement 1, revenue maximization) is as follows. The objective of the provider when designing its offering catalog is to maximize its revenue. Revenue maximization focuses on skimming the surplus of the customer in the favor of the provider, contrary to allocation efficiency which maximizes the sum (welfare of the system) of all market utilities of participants. Regarding allocation efficiency, see Myerson, R. B., “Optimal Coordination Mechanisms In Generalized Principal-Agent Problems”, Journal of Mathematical Economics, 10(1):67-81, 1982.

Research with focus on the utility maximization of a single agent is done in Myerson (cited above). Revenue maximization is analyzed for combinatorial goods in Balcan, M. F. and Blum, A. and Mansour, Y. Item pricing for revenue maximization, “Proceedings of the 9th ACM Conference on Electronic Commerce”, pages 50-59, 2008. Revenue maximization is analyzed for cloud service providers in Anandasivam, Arun and Weinhardt, Christof, “Towards an Efficient Decision Policy for Cloud Service Providers”, Proceedings of the International Conference on Information Systems (ICIS), Saint Louis, USA, 2010.

It is noted that Requirement 1 may be relaxed in some instances. For instance, a service provider might be willing to provide services for some predetermined profit, which may or may not maximal.

A second exemplary requirement (Requirement 2, multidimensional types) is as follows. In the context of services, both, price and quality are determining factors for the exchange of services in a cloud service market. Hence, an economic framework has to reflect the multidimensional nature of services in order to foster efficient contracting. It should be noted that quality itself is multidimensional in most cases, since using only one quality attribute is not sufficient in most cases.

The multidimensional screening model has been intensively studied and a rich range of approaches is available. See Armstrong, M., “Multiproduct nonlinear pricing”, Econometrica: Journal of the Econometric Society, 64(1):51-75, 1996; Basov, S., “Multidimensional screening”, Springer Verlag, 2005; Rochet, J. C. and Chone, P., “Ironing, sweeping, and multidimensional screening”, Econometrica, 66(4):783-826, 1998; Rochet, J. C. and Stole, L. A., “The economics of Multidimensional Screening”, volume 1, 2003; Berg, K. and Ehtamo, H., “Multidimensional Screening: Online Computation and Limited Information”, Proceedings of the 10th international conference on Electronic commerce, pages 41, 2008. Compared to other references, in Berg and Ehtamo (cited above), the problem of multidimensional screening is analyzed in a non-linear pricing application with a monopolistic seller. However, no known references address dependent service non-functional characteristics (NFC), which is necessary for a real-world calibration of screening.

A third exemplary requirement (Requirement 3, dependent NFCs) is as follows. Provider-related NFCs are considered to be independent (see, e.g., Koehler, P. and Anandasivam, A. and Dan, M A, “Cloud Services from a Consumer Perspective”, AMCIS 2010 Proceedings, Paper 329, 2010) while the cloud services related NFCs can be dependent. To leverage from a mathematical perspective conventional solutions which deal with independent NFCs only, the dependencies have to be aligned with the mathematical solution requirements.

NFCs in the context of cloud services are described below in reference to exemplary mapping extension embodiments.

### 4. CLOUD SERVICE CONTRACTING

In this section, the challenges and shortcomings are addressed of existing screening approaches as outlined in the above exemplary requirement analysis. The design of an exemplary optimal contracting framework for single services is described. It is briefly shown how the presented framework can be leveraged in scenarios for complex services.

4.1. Single Services

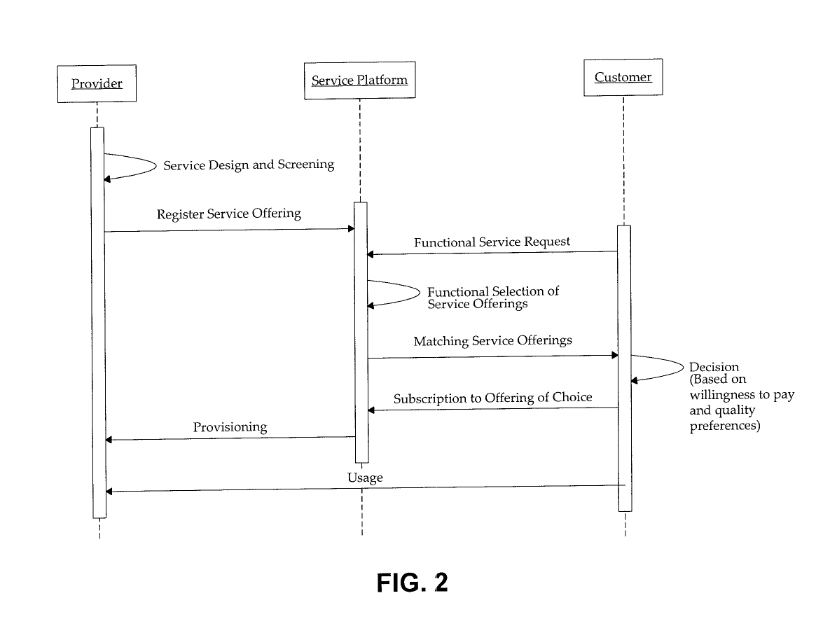

As described above, service providers are able to offer their services on the marketplace and customers can request services with certain functional requirements from the catalog of services. FIG. 2 shows a unified modeling language (UML) sequence diagram depicting the underlying scenario.

Providers start by designing a new service, apply screening (described here after) and then register the offering within the platform. Upon registering a new service in the catalog, the service is available for customer subscription. By requesting a specific functionality, the customer receives back a list of all functional wise matching services. Along with the list, the customer receives the corresponding NFCs (including prices). Hence, it is based on these NFCs and prices that the customer decides to which service to subscribe. Following a customer subscription, the service provisioning takes place and the customer can use the service.

The described scenario exhibits the phenomenon of a market with information asymmetry—the providers do not know the willingness of the customers to pay and NFC preferences at the point in time the providers have to decide which NFCs and prices should be offered to optimize their own profit. First degree price discrimination is not applicable here, since the cloud service providers are not willing to offer personalized contracts to each customer. Furthermore, it is also not really possible. For instance, how does a service provider set up a mechanism which ensures “fair” personalized pricing in such a scenario? One can find personalized pricing (although not in its pure theoretical form) for example in Scandinavia where people pay different prices for doctor consultations dependent on their salary. Such things are not really applicable here—independent from the willingness of the providers to do so. For first degree price discrimination, see Varian, H. R., “Price discrimination”, Handbook of industrial organization, 1:597-654, 1989. Similarly, third degree price discrimination (see also Varian) cannot be applied since differentiating the customers in specific types which can be verified by the provider is not a realistic scenario. The remaining second degree price discrimination (see also Varian) expects the providers to provide incentives for the customers to differentiate themselves according to preferences. At the point in time the pricing takes place, providers are not able to differentiate between different types of consumers existing in reality. The incentives are thereby built based on assumptions the providers can make about the potential customer types.

In contract theory, the above described technique to deal with assumed customer types to mitigate the information asymmetry is called screening. In the instant scenario, the provider is the uninformed party performing the screening.

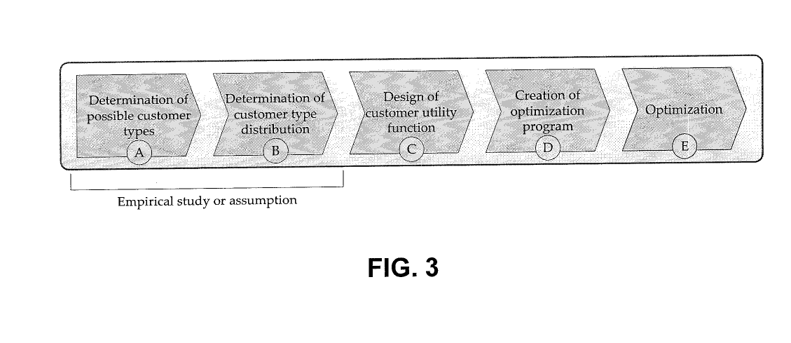

The five main steps which are used to apply screening to the instant scenario are depicted in FIG. 3 and described below. Steps A and B of FIG. 3 relate to determination of potential customer types and their distribution. In the first step of screening (step A), the provider tries to gather the unknown data, e.g., willingness to pay, distribution, NFC preferences and values for each customer type. Let the nεN customer types be dealt with by indexing by iεI={1, . . . , n}. According to exemplary Requirement 2 in Section 3, one has to consider multidimensional NFCs. The NFCs are split into two subsets: provider-related characteristics and service-related characteristics.

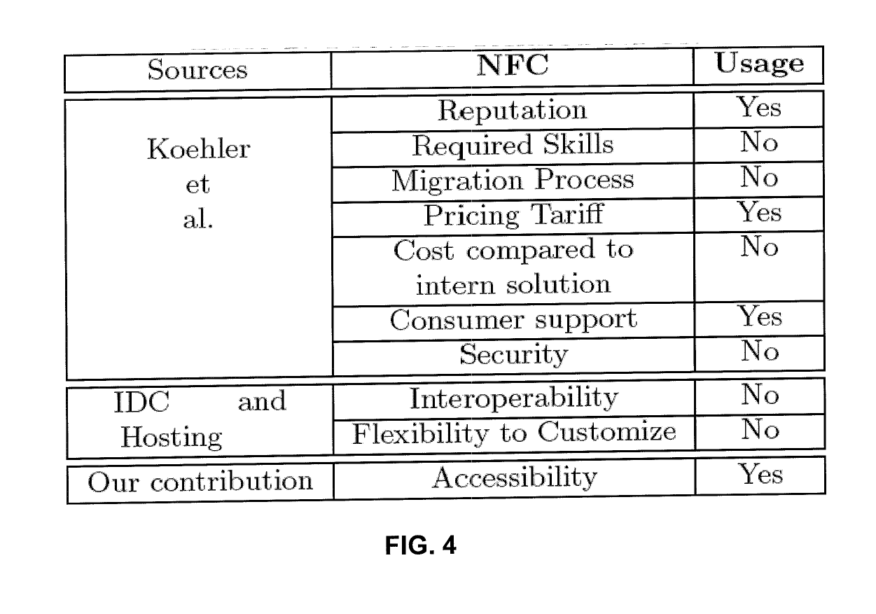

For provider-related characteristics, Koehler (cited above) provides an empirical solution to determine the provider-related NFCs by directly inquiring the customer. In the instant scenario, the provider does not have access to any of these NFC values (see Assumption 2). However, the provider can partially infer the values. For instance, the provider-related characteristics can be inferred as Koehler inferred these in the cited paper using a conjoint analysis. The first section in the table of FIG. 4 shows the important provider-related NFCs mentioned in Koehler and a decision if providers can gather the values. It should be noted that this is not the only dimension taken into account for the decision if we use a certain attribute from Koehler or not. Also some assumptions (like interoperability of services on a technical level) may be decisive. Two additional provider-related NFCs from are shown in second section of the table in FIG. 4. These two additional provider-related NFCs are described in from IDC, “IT Cloud Services Survey”, Technical report, 2009; and Hosting, “2009 Cloud Computing Trends Report”, Technical report, 2009. Finally, the last section in this table depicts our own identified NFC (Accessibility). Neither the list of NFCs from literature, nor our own NFCs list is exhaustive and the NFCs are merely exemplary. The details on the choice of usage for all NFCs are presented in the table shown in FIG. 4.

Reputation: According to Koehler (cited above) the provider reputation is the most important provider-related NFC. Providers are generally able to assess their own reputation by means of empirical studies.

Required Skills: The instant scenario is based on service marketplaces with standardized interfaces. Providers are expected to build services based on these standards. Therefore, the level of skill required to consume the service on the client side are not differentiating the providers.

Migration Process: Migration is the process to switch from an internal solution to a cloud service based solution. If providers could assess the transformation effort, this would be expected to be similar among services from different providers due to standardization. Thus, this is not a differentiating factor.

Pricing Tariff: Providers are assumed to be able to assess which customer type prefers which type of rate, e.g., flat, pay-as-you-go, freemium, and the like.

Cost compared to intern solution: Providers are not able to determine the cost of the internal solution of potential customers.

Consumer Support: Providers are assumed to be able to estimate the level of technical support required by each customer type.

Security: Security can be divided in a provider-related NFC (e.g., trust) and a service-related NFC (e.g., usage of “http” or “https”). The service-related NFC will be exemplified hereafter. The provider-related NFC is assumed to be included in the reputation NFC.

Interoperability: Due to standardized interfaces, internal (between services) as well as external (between services and customers) interoperability are required to be provided the same way for all providers and therefore not a differentiator.

Flexibility to Customize: Since customization changes the functional aspects of a service this is not a valid NFC in the instant scenario.

Accessibility: This is an important differentiating aspect to ensure that people with disabilities are able to use the service.

Note that there are provider-related NFCs, such as reputation, that are the same for all offerings of a given provider. Although these are non differentiating constants in the valuation functions, they have a differentiating fraction in the valuation functions due to the different weights of importance among customer types.

Regarding service-related characteristics, QoS (quality of service) is a good example for a set of service-related NFCs, such as availability, response time, security (e.g., the https protocol), error rate, and throughput. The complete set of service-related NFCs differs from service to service and is to be defined as part of the service design.

What has been shown above is a particular realization of step A of FIG. 3 of the instant exemplary screening process. However, other empirical techniques are suitable as well. Typically, the empirical studies that gather the customer types provide as well the customer type distributions (such as the conjoint analysis used by Koehler), βᵢ, iεI, where Σᵢ₌₁ⁿβᵢ=1 (step B of FIG. 3). In the next sections, a generic approach is presented to the subsequent screening steps C-E of FIG. 3.

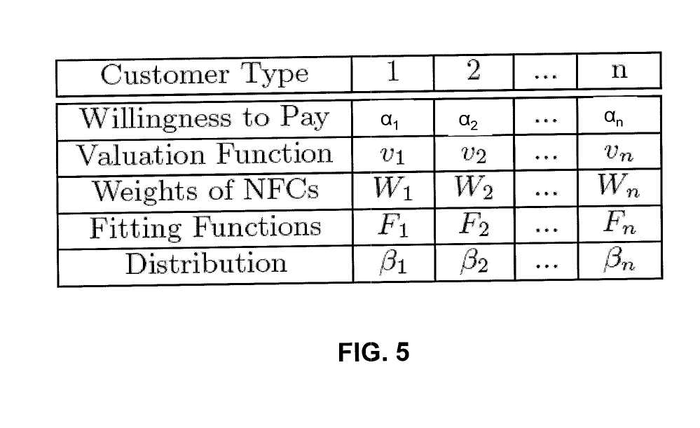

With regard to step C of FIG. 3, design of a customer utility function, assuming that there are mεN NFCs, let lεN (l≦m) be provider-related and m−1 be service-related. The mathematical expression of the empirical results of studies gathered in steps A and B of FIG. 3 is depicted in the table shown in FIG. 5.

Wᵢ=(λᵢ¹, λᵢ², . . . , λᵢ^{m})^{T}, iεI denotes the vector of NFC preference weights λᵢ^{j} which can be assessed for customer type i regarding NFC j, where Σⱼ₌₁^{m}λᵢ^{j}=1, (iεI). Fᵢ=(ƒᵢ¹, ƒᵢ², . . . , ƒᵢ^{m})^{T} denotes the vector of fitting functions for customer type iεI for all m NFCs. This mathematical representation takes in consideration the Requirement 2 for multidimensional types. It is noted the NFC preference weights (λ) and the fitting functions (ƒ) are assumed to be known. There are several possibilities to determine these: Empirical studies, assumptions, analyzing historical data (if available) dealing with this customer type, and the like.

Let q=(qₚ,qₛ)^{T} denote the vector representing all NFCs—provider-related and service-related qₛ, with qₚ=(q₁, . . . , qₗ)^{T}, qₛ=(qₗ₊₁, . . . , qₘ)^{T} and qⱼεQⱼ where Qⱼ denotes the domain of NFC j for j=1, . . . , m.

The quasi-linear design of the customer utility function is:

uᵢ(q)=αᵢνᵢ(q)−P, iεI (1)

That is, the utility (uᵢ(q)) of customer type iεI equals the product of the willingness to pay (αᵢ) and the valuation (νᵢ(q)) of the quality (consisting of provider and service-related NFCs) minus the price (P) which has to be paid for the service. Functional characteristics of the service do not have to be taken into account since our scenario is based on the assumption that a service customer gets back a list of functional equivalent services differentiated by NFC and price levels. Therefore, the decision of the customers is based only on NFCs and price.

The valuation function νᵢ is further defined as:

$${v}_{i} ( q ) = {\sum }_{j = 1}^{m} {λ}_{i}^{j} {f}_{i}^{j} ( {q}_{j} ) , i ∈ I \qquad ( 2 )$$

The mathematical characteristics which have to be fulfilled by the fitting functions ƒᵢ^{j} differ depending on the solution approach. Most of the solutions require linearity with smooth fitting functions ƒᵢ^{j} as in Equation 2. As will be described in relation to step E of FIG. 3, the Berg and Ehtamo (cited above) solution, as an example, may be used since the instant model and mathematical characteristics are similar to theirs. Furthermore, the Berg and Ehtamo solution is one with the least mathematical characteristics needed to be fulfilled by ƒᵢ^{j}, νᵢ and uᵢ to solve an optimization. It is therefore assumed without loss of generality that νᵢ(q) is smooth and either an increasing or single-humped function.

However, all solution approaches described above require a certain form of the utility function in order to be solvable. Note that one may assume provider-related NFCs as always being independent and that they can therefore always be represented by a linear valuation function.

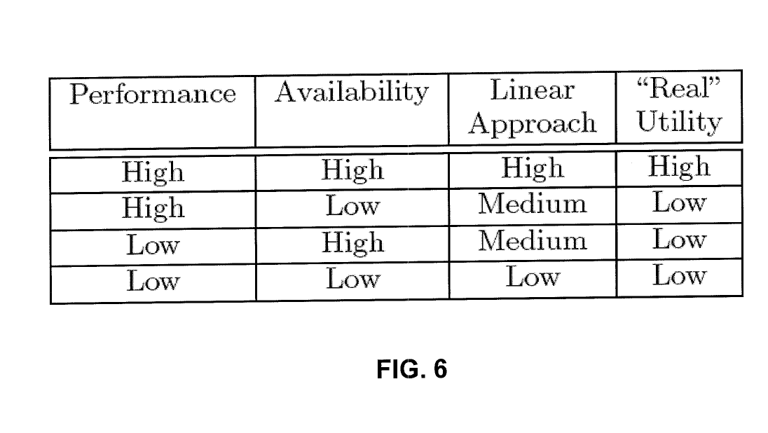

In some service NFC cases, the utility function has a complex form in order to adequately represent the reality and hence no longer fulfills the required mathematical characteristics. For instance, consider the example of a service with availability and performance NFCs. A customer utility function may involve a dependency between the two. This dependency is depicted in the table shown in FIG. 6. The linear approach matches the real utility values for the cases where customer preferences for both NFCs are in a similar range. That is, the ideal case is where customer preferences for both NFCs are equal, but the customer preferences are not required to be equal. The linear approach also leads to “good” results in case the customer preferences are similar (e.g., both in a “high” rang or both in a “low” range). However, in the cases where the NFC values are not in a similar range, the linear approach leads to “medium” not matching the “low” utility expected by this customer type who does not want the service if not both NFC values are “high”. Thus, this is a situation where a different approach is required. More specifically, the problem is to have a different approach which still fulfills the mathematical requirements to be solvable.

The following extension is applied to the instant framework based on the previous work by Sailer (Sailer, A. and Head, M. R. and Kochut, A. and Shaikh, H., “Graph-Based Cloud Service Placement”, 2010 IEEE International Conference on Services Computing, pages 89-96, 2010) to deal with such issues. The dependencies in Sailer are captured under services definition as “scalability rules”. The authors in that paper provide mechanisms to map business level NFCs to IT level resources. It is proposed herein that service-related dependent NFCs are mapped to basic IT resources that are assumed to be independent, for instance virtual machines, storage capacity, or network links, which are predefined in data center delivery catalogs (see Sailor, cited above) in terms of their constituent IT elements such as CPU (central processing unit), memory, I/O (input/output), storage volume, network throughput, network access, number of servers used in a cluster, hot swap, stand by, and the like. We map the dependent NFCs (and therefore not suitable for an exemplary embodiment of the instant approach) to these elements (out of which the NFCs evolve) to reword the problem and make the approach herein suitable for these dependent NFCs. Multiple service-related NFCs may be defined in terms of the same basic IT resources. For instance the values of the instant performance and availability NFCs considered above can be mapped to a corresponding number of particular virtual severs. Thus, a multidimensional fitting function for non-independent NFCs can be expressed in terms of IT resources through function composition (note that the multidimensional fitting function does not have to fulfill the mathematical characteristics mentioned previously to apply this mapping, as long as the result of the mapping fulfills the required characteristics.).

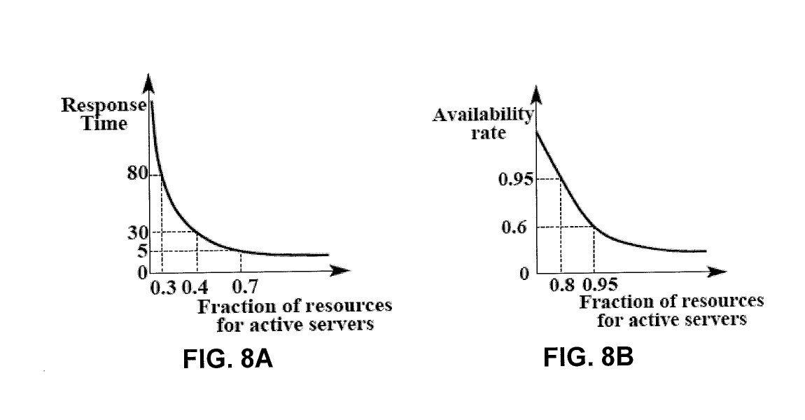

Let ƒᵢ^{Perf,Avail}(q_{Perf},q_{Avail}):R⁺×R⁺→R⁺ be the fitting function from above. Let Perf(VMCount_{Perf}):R⁺→R⁺ and Avail(VMCount_{Avail}):R⁺→R⁺ be data center properties as defined in delivery catalogs. This leads to the following composite fitting function in terms of IT resources (see also FIG. 8, including FIGS. 8A and 8B, which illustrates an application scenario):

ƒᵢ^{Perf,Avail}(Perf(VMCount_{Perf}),Avail(VMCount_{Avail})):R⁺×R⁺→R⁺.

Note that in particular situations the NFCs are mostly dependent on one IT element as it is in the case of web hosting service, where the web servers are not CPU intensive and the performance is heavily dependent on RAM. This particularity is leveraged to map the multidimensional fitting function ƒ to more granular IT terms, i.e., directly to CPU, RAM (random access memory), I/O, and the like.

Furthermore, it is proposed to reduce a multidimensional fitting function to a linear term in the valuation function by restricting the fitting function mapped to IT resources using IT resource dependency constraints. An example of such a constraint in our performance and availability NFC case, is that the number of servers, both active VMCount_{Perf} and stand-by VMCount_{Avail}, reserved for a service, is constant: VMCount_{Perf}+VMCount_{Avail}=c.

Thus, the more servers are used for stand-by, the higher the availability and the lower the performance for a given workload. The constraint hence limits the range of choices in the domain of our fitting function ƒ mapped to VMCount resources from R⁺×R⁺ to single R⁺, enabling the valuation function to be expressed such that it allows the mathematical equations to be solvable. In general, it is assumed the constraints among the IT resources and IT elements are sufficient to reduce the multidimensional domain of complex fitting functions (with multiple dependent NFCs) to one dimension (with one or more independent NFCs). In Section 5, details are provided of how the linearity can be achieved for IT cloud services.

Regarding step D, creation of optimization program, of FIG. 3, a mathematical optimization is formulated. This formulation should fulfill the following requirements:

1. The target function should maximize the providers profit to reflect Requirement 1 (e.g., or create a predetermined profit).

2. Individual rationality (IR): Individual rationality means that the customers are not worse-off by participating in the market. That is, the utility of a customer of a certain customer type has to be greater than or equal to zero for each offered service.

3. Incentive compatible (IC): A mechanism is incentive compatible if agents report truthful information about their preferences in equilibrium. That is (in the instant case), each customer assigned to a certain customer type should have an incentive to choose the solution assigned to the customer type represented. That is, the utility of a certain customer choosing the service designed for the customer type represented by this customer should be greater than or equal to the utility if this customer chooses another service designed for a different customer type.

These design goals lead to the following mathematical formulation:

1. Providers try to find contracts (qⁱ,Pⁱ)*, iεI to optimize their own profit (cf. Requirement 1), where the asterisk indicates an optimal version. That is

$${( {q}^{i} , {P}^{i} )}^{*} = {arg max}_{( {q}^{i} , {P}^{i} )} {\sum }_{i = 1}^{n} ( {P}^{i} - c ( {q}^{i} ) ) {β}_{i} \qquad ( 3 )$$

with qⱼⁱεQⱼ (cf. step C of FIG. 3) and Pε[0,∞). Equation (3) depicts the profit of the provider, which is the sum of the terms price (P) minus quality dependent costs (c(qⁱ)) to provide the service for all customer types iεI weighted by the probability βᵢ (i.e., a customer type distribution) to have a customer type i. Obviously this term should be maximized over q and P to achieve the goal and to get the required results, which are the NFC values and prices (i.e., the price pairs (qⁱ,Pⁱ)*, iεI). It is assumed without loss of generality that the cost function c is smooth on the whole domain.

2. Individual rationality:

αᵢνᵢ(q^{i*})−P^{i*}≧0 ∀ᵢ (4)

3. Incentive compatible:

αᵢνᵢ(q^{i*})−P^{i*}≧αᵢνᵢ(q^{h*})−P^{h*} ∀_{i,h} (5)

Hence, an exemplary resulting optimization formulation is given by Equations 3, 4, and 5.

This problem formulation reflects all exemplary requirements described in Section 3: Requirement 1 (revenue maximization), Requirement 2 (multidimensional types), and with the above described mapping extension also Requirement 3 (dependent NFCs). That is, the mapping extension provides an approach to handle dependent NFCs.

Regarding step E, optimization, of FIG. 3, a lot of research has been performed on solving optimization programs evolving out of multidimensional screening approaches in different domains. However, each screening application has its own mathematical characteristics and should be treated differently. Most of the available work focuses on solving the screening program with a linear approach of the utility function (i.e., independent NFCs) along with the IC and IR constraints. As mentioned above, one can formulate the instant problem having these characteristics. In case utility functions with different characteristics are needed to represent the reality, one is able to map the business requirements to IT requirements, thus leading to a linear approach which is solvable by well known algorithms. That is, the problem set up above may be solved by any number of well known algorithms for solving linear or non-linear problems.

Therefore, a detailed mathematical explanation of available solution approaches is not considered here. The interested reader is pointed to the following related literature for exemplary detailed descriptions. First insights into mathematical aspects of one-dimensional screening as well as multidimensional screening are given in Bolton, P. and Dewatripont, M., “Contract theory”, The MIT Press, 2005. A comprehensive review of the model which leads to the optimization is presented by Rochet, J. C. and Stole, L. A., “The economics of multidimensional screening”, volume 1 (2003). Basov (Basov, S., “Three approaches to multidimensional screening”, Progress in Economics Research, 7:159-178, 2004) presents a brief overview of three well known approaches: “direct approach”, “dual approach” and “Hamiltonian Approach” to deal with the multidimensional problem. A more detailed insight to these approaches is given in Basov, S., “Multidimensional screening”, Springer Verlag, 2005. These approaches are extended for the “Hamiltonian Approach” in Basov, S., “Hamiltonian approach to multi-dimensional screening”, Journal of Mathematical Economics, 36(1):77-94, 2001. More sophisticated approaches can be found in Berg and Ehtamo (cited above) and Rochet and Chone (cited above). As mentioned above, especially the work of Berg and Ehtamo deals with a model which is similar to the instant model from a mathematical point of view. Thus, their work can be used to gain deeper insights into the mathematical solution for a problem like the one stated above.

However, all known approaches deal with the assumption that the fitting functions (on which the valuation function is based) have an interval in R as domain, that is ƒᵢ^{j}:[a,b]→[0,1] with a,bεR ∀_{i,j} and are smooth on [a,b]. Some of the instant NFCs, like VMCount, CPU or RAM, which are IT attributes that evolve out of the mapping proposed herein, typically have a finite set of discrete values as a domain.

However, one unique feature of cloud computing (and virtualization in general) is that the granularity at which resources can be configured is much finer. For example, if in case of physical servers, only certain discrete configurations of memory size are possible (e.g., 1 GB (gigabytes), 2 GB, etc.), in case of virtual machines, one can assign an arbitrary fraction of memory of a host to a virtual machine. Therefore, in the cloud context, one can consider continuous values for resource allocations rather than discrete values.

### 5. EXEMPLARY APPLICATION SCENARIO

The application of screening to IT cloud marketplaces is illustrated here in case of desktop cloud service (DCS). This is an application of virtualization technology to desktop computing. In the DCS computing model, users connect to virtual machines running desktop operating systems on servers in a remote data center. Users interact with their desktops via remoting protocols (e.g., RDP, remote desktop protocol, and ICA, independent computing architecture) using thin-client devices that provide the GUI (graphical user interface) interaction but do not necessarily perform any end-user computing. Desktop service can be provided with varying levels of responsiveness, availability, and cost. Depending on the customer type requirements, different flavors of desktop service may be offered.

The following three types of DCS customers are considered: “Library”, “Internet cafe”, and “Investment bank”. They exemplify varying levels of expectations in terms of quality of support, reputation of the provider, response time, and availability. A typical reason for a library to subscribe to DCS is to provide free Internet access as an addition to its primary mission of providing access to printed material. Therefore, since Internet access is not the primary focus of the library, the main concern of the library is the cost of the service, while the availability and response time aspects are less important. On the contrary, an Internet cafe relies primarily on revenue from users accessing Internet and therefore its concern is having the desktops highly available and responsive. Unresponsive or faulty desktops will discourage customers from using the Internet cafe and therefore reduce its revenue. At the same time, the Internet cafe is concerned with cost of the service, since the cost of providing the desktops is a substantial fraction of its revenue. The third customer type, investment bank, has very high requirements for NFCs, such as availability, and reputation of the provider. Additionally, since IT expenses are only a small fraction of the potential revenue and profit, an investment bank is willing to accept high prices for high quality services.

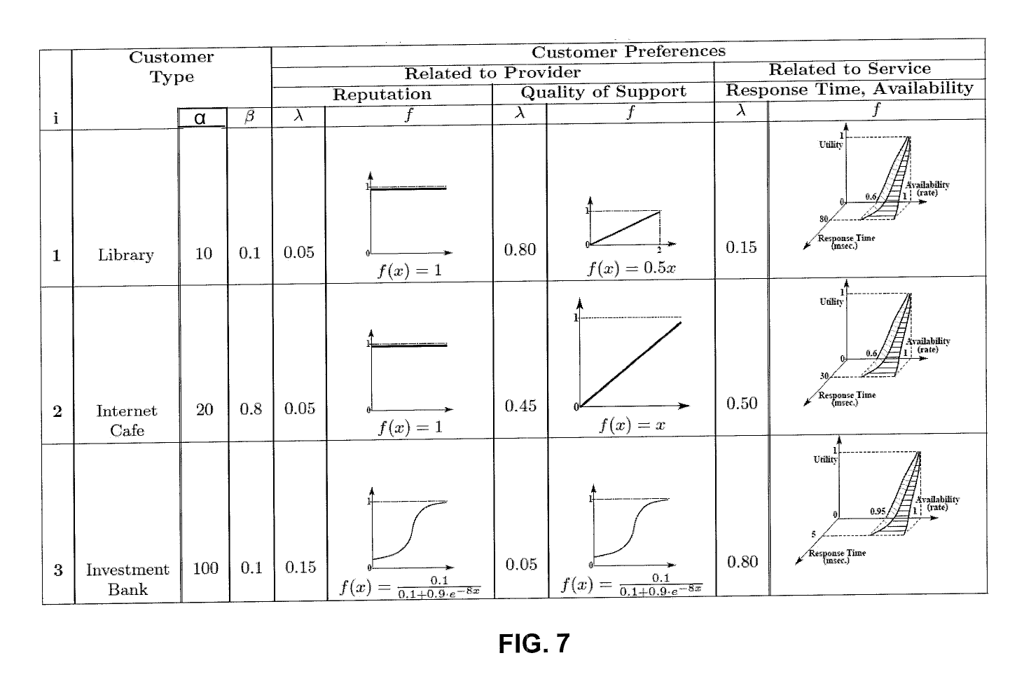

The table shown in FIG. 7 lists the attribute valuations of the NFCs. The numerical values of the λᵢ^{j} weights and the utility function shapes are chosen to represent the properties of the customer types described above. In this example, the provider-related NFCs are reputation and quality of support. Both range between 0 (zero) and 1 (one) with 0 (zero) denoting the lowest and 1 (one) the highest level of reputation and quality of support. The service-related NFCs represent quality of service which has two dimensions, virtual desktop responsiveness and system availability. Since the two dimensions are correlated, their customer valuation is presented as a surface. The shape of the surface is similar for all three customer types, except the boundary of zero valuation changes. For example, the library is much more tolerant of latency and lack of system availability (80 msec., millisecond, and 0.6) than the investment bank (5 msec. and 0.95).

In order to be able to apply the screening model, the two-dimensional service NFC fitting function (i.e., fitting function) is mapped to the IT resource domain, using the infrastructure profiles illustrated in FIG. 8 (including FIGS. 8A and 8B). It is assumed that the data center has a fixed amount of resources (e.g., physical servers) for provisioning both, primary hosting desktops and standby hosts (e.g., to take over the workload in case of failure of primary servers). The service provider determines the ratio of how many primary versus standby servers to use for each customer type. Therefore, desktop responsiveness and system availability are modeled as a function of this ratio of physical resources. The larger the ratio of servers dedicated to serve the workload, the lower the average response time (see FIG. 8A). However, this implies a smaller fraction for standby hosts and therefore a lower level of availability (see FIG. 8B).

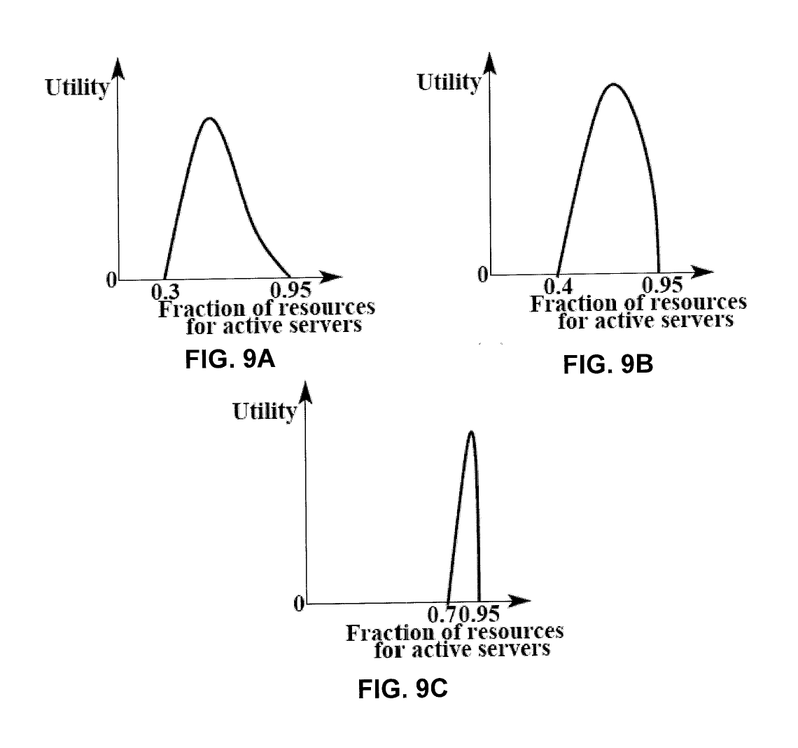

Next, the infrastructure profiles in FIG. 8 are combined with the utility surfaces as shown in the table in FIG. 7 to obtain the valuation functions which are illustrated in FIGS. 9A (library), 9B (internet cafe), and 9C (investment bank). Thus, for each customer type, the valuation function is modeled as a function of the ratio of the resources dedicated to primary versus standby servers.

The optimization problem presented in Section 4 by Equations 3, 4, and 5, can now be instantiated with data as following.

Target function (Equation 3):

1) Distribution of types βᵢ for i=1, 2, 3 (see the table shown in FIG. 7); and

2) An exemplary linear cost structure is assumed with the following form of c(q):

c(q)=40·(q^{Rep}+q^{Sup}+q^{IT}).

Individual rationality (Equation 4) and Incentive compatibility (Equation 5):

1) Willingness to pay αᵢ for i=1, 2, 3 (see the table shown in FIG. 7).

2) Valuation function νᵢ for i=1, 2, 3 using:

2a) Weighting factors λᵢ^{j} for i=1, 2, 3, and j=Rep, Sup, IT (see the table shown in FIG. 7).

2b) Fitting functions ƒᵢ^{j} for i=1, 2, 3 and j=Rep, Sup, IT (see the table shown in FIG. 7).

To reduce complexity of the presented example, the presented fitting functions are approximated for performance related attributes by second degree polynomial functions of the form ƒ^{IT}(x)=ax²+bx+c:

$${f}_{library}^{IT} = - \frac{1600}{169} {x}^{2} + \frac{2000}{169} x - \frac{456}{169} , \\ {f}_{intcafe}^{IT} = - \frac{1600}{121} {x}^{2} + \frac{2160}{121} x - \frac{608}{121} , \\ {f}_{bank}^{IT} = - 64 {x}^{2} + \frac{528}{5} x - \frac{1064}{25} .$$

Approximated functions have the same roots z₁ and z₂ as the functions depicted in FIG. 9 and a fitting output of 1 at

$$x = \frac{1}{2} \cdot ( {z}_{1} + {z}_{2} ) .$$

Furthermore it holds that q_{library}^{Rep}=q_{intcafe}^{Rep}=q_{bank}^{Rep} since a single provider is not able to offer different levels of reputation to different customers. Taking reputation into account remains important since the result of our empirical studies prior to the optimization leads to values for reputation which are related to competitors and therefore the contract has to reflect the assumed reputation level. It is assumed that reputation level for the provider is q^{Rep}=0.8. The solution of the optimization problem above can be obtained using approaches discussed in Section 4.

### 6. ADDITIONAL IMPLEMENTATION EXAMPLES

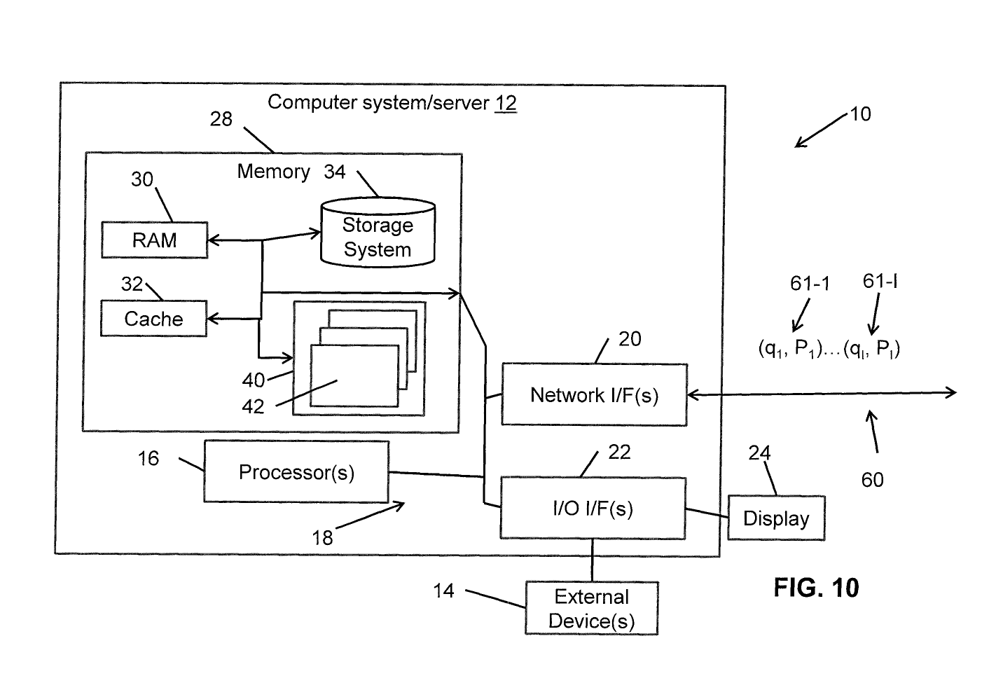

FIG. 10 is a block diagram of an exemplary system for performing exemplary embodiments of the instant invention. Referring now to this figure, a schematic of an example of a computing node is shown. Computing node 10 is only one example of a suitable computing node and is not intended to suggest any limitation as to the scope of use or functionality of embodiments of the instant invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs (personal computers), minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in, e.g., distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 12 in cloud computing node 10 is shown in the form of a general-purpose computing device. The components of computer system/server 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and the media may include both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (typically called a “hard drive”). Storage system 34 may also include a magnetic disk drive for reading from and writing to a removable, non-volatile magnetic disk (e.g., a “floppy disk”), or an optical disk drive for reading from or writing to a removable, non-volatile optical disk such as a CD-ROM (compact disk-read only memory), DVD-ROM (digital versatile disc-read only memory) or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the instant invention.

Program 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, and the like; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via wired or wireless network adapter 20 and link(s) 60. As depicted, network adapter 20 communicates with the other components of computer system/server 12 via bus 18. In this example, there are I quality-price pairs 61-1 through 61-I that are communicated to a service provider, as a result of the algorithm presented above.

It should be understood that although not shown, other hardware and/or software components could be used in conjunction with computer system/server 12. Examples, include, but are not limited to: microcode, device drivers, redundant processing units, external disk drive arrays, RAID (redundant array of independent disks), tape drives, and data archival storage systems, and the like.

### 7. CONCLUSION

The current trend of cloud ecosystems enables buyers and suppliers to come together to buy and sell IT services. From a supplier perspective, the task of computing the contracts (including price and NFC values) for services which shall be offered is a critical procedure to maximize their profit. Providers are faced with information asymmetry since they do not know the customer preferences at the point in time the contracts have to be specified. Thus, the providers have to deal with the economic phenomenon of adverse selection which fosters a spiral of decreasing service quality leading to a low quality market with minimum revenues.

To address the adverse selection challenge, a holistic contracting framework was provided in the context of, e.g., cloud service marketplaces. It is noted that while cloud service marketplaces was provided as the primary example herein, the instant embodiments are not limited thereto. An exemplary instant approach is based on screening, which is a typical technique to cope with the adverse selection phenomenon. Non-functional service and provider characteristics were first identified that influence the decision of the customers in buying a service. Based on these characteristics, potential customers are grouped into customer types for which the providers will target their differentiated services. Providers utilizing the instant framework are required to assess the non-functional characteristics for each customer type and the customer type distributions. Second, profit optimal prices and values of non-functional characteristics are computed based on the assumption of the utility functions and distributions for customer types. From a mathematical point of view, the optimization problem has to fulfill certain characteristics to be solvable. In reality, the customer preferences cannot always be represented with all these mathematical constraints that have to be fulfilled. The instant framework was therefore extended by a methodology which enables the mapping of customer preferences to IT level resources, thus enabling a solvable version of the optimization problem. Incentive compatibility and individual rationality constraints are used in the optimization to ensure the correct self selection of customers in our second degree price discrimination. Finally, to demonstrate the applicability of the instant framework in real world, an application scenario was provided for IT cloud using desktop cloud service.

Techniques have been presented that may perform the following: determining utility of customers based on a plurality of customer types and based on a plurality of qualities, the qualities based at least on a previously identified plurality of non-functional characteristics of services that influence decisions of the customers in buying the services from a service provider; based at least on the utility, determining a plurality of quality-price pairs to create a predetermined amount of profit for the service provider assuming the service provider offers the services to a customer having the customer type at a level of quality corresponding to an associated one of the qualities in a pair and for the corresponding price in the pair, wherein each quality in the plurality of pairs corresponds to one of the plurality of customer types; and outputting indications of the plurality of quality-price pairs.

The above techniques, wherein the non-functional characteristics comprise one or both of service-related or service-provider-related characteristics. The above techniques, wherein the service-related characteristics are mapped to information technology resources for those service-related characteristics that are dependent on other service-related characteristics. The above techniques, wherein determining a plurality of quality, price pairs comprises: determining the predetermined amount of profit subject to a constraint that the utility of each offered service is greater than or equal to zero for each customer type and subject to a constraint that the utility of a service designed for a customer type should be greater than or equal to the utility of another service designed for a different customer type is chosen.

The above techniques, wherein determining the plurality of quality-price pairs further comprises for all of the quality-price pairs maximizing a weighted difference between the price for a selected pair minus cost to provide the services, the cost dependant on the corresponding quality in the selected pair. The above techniques, wherein determining the plurality of quality-price pairs further comprises weighting the difference between the price for a pair minus cost to provide the services by using a probability determined from a customer type distribution for a corresponding one of the customer types.

The above techniques, wherein determining the utility comprises determining a utility corresponding to a selected customer type by determining a difference between a weighted valuation of a corresponding quality and a price, the weight corresponding to a willingness for the selected customer type to pay for the service.

The above techniques, wherein the valuation comprises, for a selected customer type, determining for each of the plurality of non-functional characteristics a result of a multiplication of a preference weight with a corresponding fitting function and adding the results to determine a value for the valuation, the preference weight corresponding to preference for the customer type for a corresponding one of the non-functional characteristics, the fitting function corresponding to a customer type and determining a value of utility for a corresponding one of the non-functional characteristics.

The above technique, further including for a fitting function having two or more non-functional characteristics dependent on each other, mapping the fitting function to one or more new fitting functions having new non-functional characteristics that are independent from each other.

The above techniques, wherein the valuation additionally comprises determining a value for another fitting function for functional characteristics for the selected customer type and adding the value for the valuation to the value for the fitting function to create a result for the valuation.

These techniques may be implemented by methods, apparatus, or program products. For instance, an apparatus could include one or more memories comprising computer-readable code; one or more processors, the one or more processors configured in response to execution of the computer-readable code to cause the apparatus to perform the following: determining utility of customers based on a plurality of customer types and based on a plurality of qualities, the qualities based at least on a previously identified plurality of non-functional characteristics of services that influence decisions of the customers in buying the services from a service provider; based at least on the utility, determining a plurality of quality-price pairs to create a predetermined amount of profit for the service provider assuming the service provider offers the services to a customer having the customer type at a level of quality corresponding to an associated one of the qualities in a pair and for the corresponding price in the pair, wherein each quality in the plurality of pairs corresponds to one of the plurality of customer types; and outputting indications of the plurality of quality-price pairs.

A program product may include a computer-readable memory comprising computer-readable code, the computer-readable code comprising the following: code for determining utility of customers based on a plurality of customer types and based on a plurality of qualities, the qualities based at least on a previously identified plurality of non-functional characteristics of services that influence decisions of the customers in buying the services from a service provider; code for, based at least on the utility, determining a plurality of quality-price pairs to create a predetermined amount of profit for the service provider assuming the service provider offers the services to a customer having the customer type at a level of quality corresponding to an associated one of the qualities in a pair and for the corresponding price in the pair, wherein each quality in the plurality of pairs corresponds to one of the plurality of customer types; and code for outputting indications of the plurality of quality-price pairs.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An apparatus, comprising:
one or more memories comprising computer-readable code;
one or more processors, the one or more processors configured in response to execution of the computer-readable code to cause the apparatus to perform the following:
accessing predetermined utility of customers based on a plurality of customer types and based on a plurality of qualities, the qualities based at least on a previously identified plurality of non-functional characteristics of services that influence decisions of the customers in buying the services from a service provider, wherein the non-functional characteristics comprise service-provider-related characteristics and service-related characteristics;
based at least on the accessed predetermining utility, determining a plurality of quality-price pairs to create a predetermined amount of profit for the service provider assuming the service provider offers the services to a customer having the customer type at a level of quality corresponding to an associated one of the qualities in a pair and for the corresponding price in the pair, wherein each quality in the plurality of pairs corresponds to one of the plurality of customer types, and wherein determining the plurality of price-quality pairs further comprises mapping at least one of the service-related characteristics to one or more information technology resources in response to the at least one service-related characteristics being dependent on at least one other service-related characteristic; and
outputting indications of the plurality of quality-price pairs.

2. The apparatus of claim 1, wherein determining a plurality of quality, price pairs comprises:
determining the predetermined amount of profit subject to a constraint that the utility of each offered service is greater than or equal to zero for each customer type and subject to a constraint that the utility of a service designed for a customer type should be greater than or equal to the utility of another service designed for a different customer type is chosen.

3. The apparatus of claim 2, wherein determining the plurality of quality-price pairs further comprises for all of the quality-price pairs maximizing a weighted difference between the price for a selected pair minus cost to provide the services, the cost dependant on the corresponding quality in the selected pair.

4. The apparatus of claim 3, wherein determining the plurality of quality-price pairs further comprises weighting the difference between the price for a pair minus cost to provide the services by using a probability determined from a customer type distribution for a corresponding one of the customer types.

5. The apparatus of claim 1, wherein determining the utility comprises determining a utility corresponding to a selected customer type by determining a difference between a weighted valuation of a corresponding quality and a price, the weight corresponding to a willingness for the selected customer type to pay for the service.

6. The apparatus of claim 5, wherein the valuation comprises, for a selected customer type, determining for each of the plurality of non-functional characteristics a result of a multiplication of a preference weight with a corresponding fitting function and adding the results to determine a value for the valuation, the preference weight corresponding to preference for the customer type for a corresponding one of the non-functional characteristics, the fitting function corresponding to a customer type and determining a value of utility for a corresponding one of the non-functional characteristics.

7. The apparatus of claim 6, wherein mapping at least one of the service-related characteristics to one or more information technology resources further comprises: for a fitting function having two or more non-functional service-related characteristics dependent on each other, mapping the fitting function to one or more new fitting functions having new characteristics that are independent from each other and that are based on information technology resources.

8. A method, comprising:
accessing predetermined utility of customers based on a plurality of customer types and based on a plurality of qualities, the qualities based at least on a previously identified plurality of non-functional characteristics of services that influence decisions of the customers in buying the services from a service provider, wherein the non-functional characteristics comprise service-provider-related characteristics and service-related characteristics;
based at least on the accessed predetermining utility, determining a plurality of quality-price pairs to create a predetermined amount of profit for the service provider assuming the service provider offers the services to a customer having the customer type at a level of quality corresponding to an associated one of the qualities in a pair and for the corresponding price in the pair, wherein each quality in the plurality of pairs corresponds to one of the plurality of customer types, and wherein determining the plurality of price-quality pairs further comprises mapping at least one of the service-related characteristics to one or more information technology resources in response to the at least one service-related characteristics being dependent on at least one other service-related characteristic; and
outputting indications of the plurality of quality-price pairs.

9. The method of claim 8, wherein determining a plurality of quality, price pairs comprises:
determining the predetermined amount of profit subject to a constraint that the utility of each offered service is greater than or equal to zero for each customer type and subject to a constraint that the utility of a service designed for a customer type should be greater than or equal to the utility of another service designed for a different customer type is chosen.

10. The method of claim 9, wherein determining the plurality of quality-price pairs further comprises for all of the quality-price pairs maximizing a weighted difference between the price for a selected pair minus cost to provide the services, the cost dependant on the corresponding quality in the selected pair.

11. The method of claim 10, wherein determining the plurality of quality-price pairs further comprises weighting the difference between the price for a pair minus cost to provide the services by using a probability determined from a customer type distribution for a corresponding one of the customer types.

12. The method of claim 8, wherein determining the utility comprises determining a utility corresponding to a selected customer type by determining a difference between a weighted valuation of a corresponding quality and a price, the weight corresponding to a willingness for the selected customer type to pay for the service.

13. The method of claim 12, wherein the valuation comprises, for a selected customer type, determining for each of the plurality of non-functional characteristics a result of a multiplication of a preference weight with a corresponding fitting function and adding the results to determine a value for the valuation, the preference weight corresponding to preference for the customer type for a corresponding one of the non-functional characteristics, the fitting function corresponding to a customer type and determining a value of utility for a corresponding one of the non-functional characteristics.

14. The method of claim 13, wherein mapping at least one of the service-related characteristics to one or more information technology resources further comprises: for a fitting function having two or more non-functional service-related characteristics dependent on each other, mapping the fitting function to one or more new fitting functions having new characteristics that are independent from each other and that are based on information technology resources.

15. A program product including a computer-readable memory comprising computer-readable code, the computer-readable code comprising the following:
code for accessing predetermined utility of customers based on a plurality of customer types and based on a plurality of qualities, the qualities based at least on a previously identified plurality of non-functional characteristics of services that influence decisions of the customers in buying the services from a service provider, wherein the non-functional characteristics comprise service-provider-related characteristics and service-related characteristics;
code for, based at least on the accessed predetermining utility, determining a plurality of quality-price pairs to create a predetermined amount of profit for the service provider assuming the service provider offers the services to a customer having the customer type at a level of quality corresponding to an associated one of the qualities in a pair and for the corresponding price in the pair, wherein each quality in the plurality of pairs corresponds to one of the plurality of customer types, and wherein determining the plurality of price-quality pairs further comprises mapping at least one of the service-related characteristics to one or more information technology resources in response to the at least one service-related characteristics being dependent on at least one other service-related characteristic; and
outputting indications of the plurality of quality-price pairs.

16. The program product of claim 15, wherein determining a plurality of quality, price pairs comprises:
code for determining the predetermined amount of profit subject to a constraint that the utility of each offered service is greater than or equal to zero for each customer type and subject to a constraint that the utility of a service designed for a customer type should be greater than or equal to the utility of another service designed for a different customer type is chosen.

17. The program product of claim 16, wherein the code for determining the plurality of quality-price pairs further comprises code for, for all of the quality-price pairs, maximizing a weighted difference between the price for a selected pair minus cost to provide the services, the cost dependant on the corresponding quality in the selected pair.

18. The program product of claim 17, wherein the code for determining the plurality of quality-price pairs further comprises code for weighting the difference between the price for a pair minus cost to provide the services by using a probability determined from a customer type distribution for a corresponding one of the customer types.

19. The program product of claim 15, wherein the code for determining the utility comprises code for determining a utility corresponding to a selected customer type by determining a difference between a weighted valuation of a corresponding quality and a price, the weight corresponding to a willingness for the selected customer type to pay for the service.

20. The program product of claim 19, wherein the valuation comprises, for a selected customer type, code for determining for each of the plurality of non-functional characteristics a result of a multiplication of a preference weight with a corresponding fitting function and adding the results to determine a value for the valuation, the preference weight corresponding to preference for the customer type for a corresponding one of the non-functional characteristics, the fitting function corresponding to a customer type and determining a value of utility for a corresponding one of the non-functional characteristics.

21. The program product of claim 20, wherein the code for mapping at least one of the service-related characteristics to one or more information technology resources further comprises: code for, for a fitting function having two or more non-functional service-related characteristics dependent on each other, mapping the fitting function to one or more new fitting functions having new characteristics that are independent from each other and that are based on information technology resources.
